(19) United States
(12) Patent Application Publication
(10) Pub. No.: US 2005/0097794 A1
(43) Pub. Date: May 12, 2005

(54) Self-hanging poster board

(76) Inventor: Catherine H. Wescott, Beavercreek, OH (US)

Correspondence Address: THOMPSON HINE L.L.P., 2000 COURTHOUSE PLAZA , N.E., 10 WEST SECOND STREET, DAYTON, OH, 45402, US

(21) Appl. No.: 10/703,933

(22) Filed: Nov. 7, 2003

(51) Int. Cl. G09F 7/00

(52) U.S. Cl. 40/584

(57) ABSTRACT

A poster board system including a piece of sheet-like material having a front surface and a rear surface. At least one portion of hook material is coupled to the rear surface of the piece of sheet-like material. The hook material is a portion of hook-and-loop fastening material having an average hook length of less than about 1.5 millimeters.

### BACKGROUND

The present invention relates to poster board systems, and more particularly, to a poster board system that can be hung from a fabric surface or the like.

Poster boards may be used in home, classroom or office environments for various display purposes, and typically provide a surface upon which a user can write or post various items. However, most poster boards require adhesives, tacks, clips or other devices to attach the poster board to a mounting surface. Accordingly, there is a need for a poster board that can be attached to a mounting surface without requiring adhesives, tacks, clips or the like.

### SUMMARY

The present invention is a poster board system including a poster board that can be attached to a mounting surface without the use of adhesives, tacks, clips or the like. In one embodiment, the poster board of the present invention utilizes hooks located on a rear surface of the poster board.

In one embodiment, the present invention is a poster board system that includes a piece of sheet-like material having a front surface and a rear surface. At least one portion of hook material is coupled to the rear surface of the piece of sheet-like material. The hook material is a portion of hook-and-loop fastening material having an average hook length of less than about 1.5 millimeters.

In another embodiment, the present invention is a poster board system that includes a piece of sheet-like material having a front surface and a rear surface. At least one portion of hook material, such as hook-and-loop fastening material, is coupled to the rear surface of the piece of sheet-like material. The piece of sheet-like material includes a plurality of outer edges and the at least one portion of hook material extends between two of the outer edges.

Other objects and advantages of the present invention will be apparent from the following description, the accompanying drawings and the appended claims.

### BRIEF DESCRIPTION OF THE DRAWINGS

The invention can be understood with reference to the following drawings. In the drawings like reference numerals designate corresponding parts throughout the several views.

FIG. 1 is a rear view of the poster board system of the present invention;

FIG. 2 is a top plan view of a strip of hook material;

FIG. 3 is a side elevational view of the strip of hook material of FIG. 2 located on a section of the poster board;

FIG. 4 is a front perspective view of the poster board system of FIG. 1 attached to a mounting surface; and

FIG. 5 is a front elevational view of the poster board system of FIG. 1 attached to a mounting surface.

### DETAILED DESCRIPTION

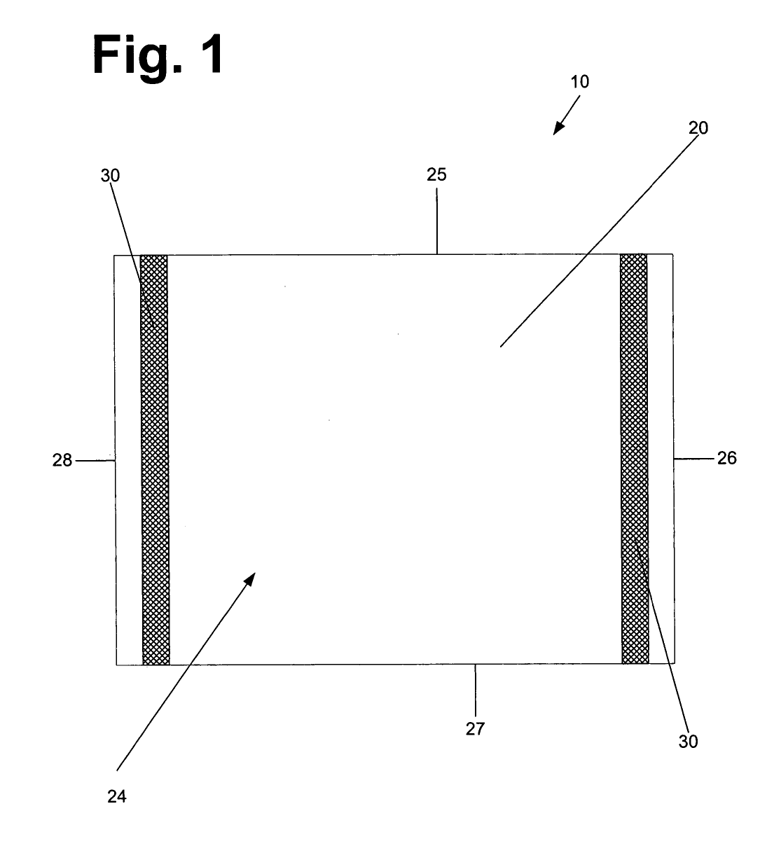

With reference to FIGS. 1, 4 and 5, the poster board system of the present invention, generally designated 10, includes a piece of sheet-like material, such as poster board 20, that has a front surface 22 and a rear surface 24. The poster board 20 may be generally rectangular in shape and has outer edges 25, 26, 27, 28. The poster board 20 may be a cellulose based poster board (i.e., that is made from wood-based pulp material) such as solid bleached sulfate (SBS) poster board, on which the user can make markings, such as by ink (both solvent and water based), paint, pencil, or various other media. The front surface 22 of the poster board 20 may be coated with a polymeric material, or may be made of a cellulose-based material. However, the poster board 20 may be made from a wide variety of other materials without departing from the scope of the present invention.

The poster board 20 may be made of a relatively thin material such that the poster board 20 is generally flexible. In one case, the poster board 20 may have a thickness of less than about 0.05 inches, or may be between about 0.010 and 0.016 inches thick.

As noted above, the poster board 20 may be generally rectangular in front view. For example, the poster board 20 may have a length of about 14 inches and a width of about 11 inches, or a length of about 28 inches and a width of about 22 inches, or various other dimensions. The poster board 20 may have a surface area of at least about 80 square inches. Additionally, the poster board may have a round, square, diamond or other like shape, and may have various geometries, dimensions, and surface areas.

The rear surface 24 of the poster board 10 may include two strips of hook material 30 or micro-hook material located thereon. The strips of hook material 30 extend substantially along the entire width of the poster board 20 (i.e., from outer edge 25 to outer edge 27) along the side edges 26, 28. Instead of, or in addition to, the generally vertically extending strips 30, the poster board 20 may include strips of hook material 30 extending substantially along the outer edges 25, 27 of the poster board 20 (i.e., from outer edge 26 to outer edge 28).

Furthermore, although only two strips of hook material 30 are included in the illustrated embodiment, additional strips of hook material 30 may be provided as desired to provide more areas of attachment. Still furthermore, the strips 30 may be oriented in a wide variety of configurations.

The strips of hook material 30 may be fixedly attached to the rear surface 24 of the poster board 20 by various methods, including a lamination process (for example, as disclosed in U.S. Pat. No. 5,744,080, the contents of which are hereby incorporated by reference), chemical or thermal adhesion, mechanical attachments, and the like. When the strips of hook material 30 are attached to the poster board 20 by lamination, the strips 30 may be formed directly onto the poster board 20 when the strips 30 are in a liquid or plastic state, and may be cooled or cured such that the strips 30 are formed on and bond directly to the poster board 20.

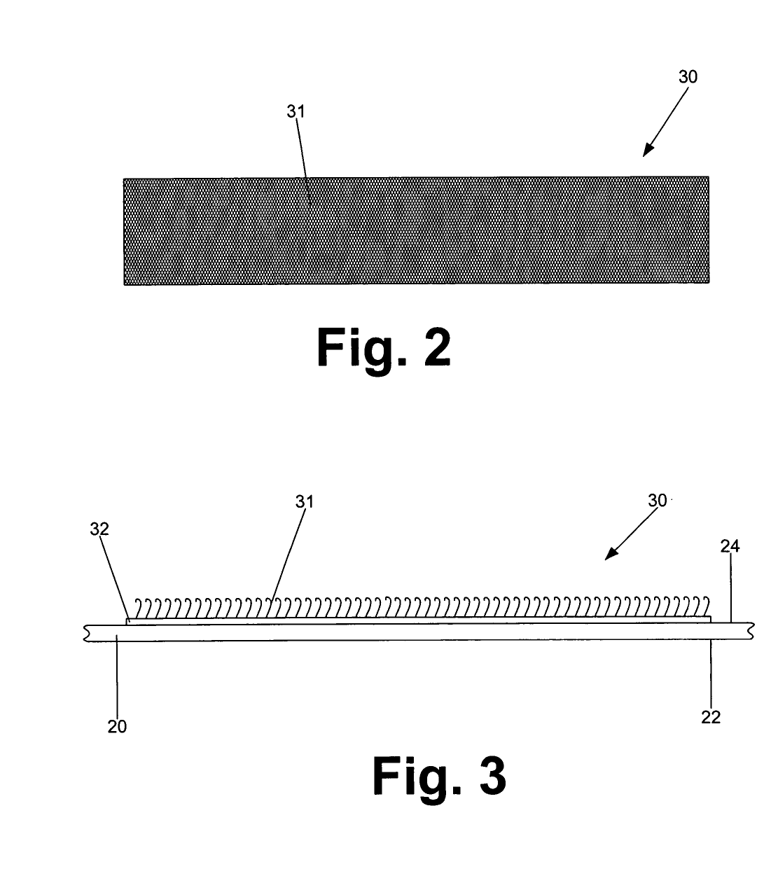

As best shown in FIGS. 2 and 3, the strips of hook material 30 may be comprised of strips of hooks of a polymeric hook-and-loop fastening material, such as Velcro®. The hooks 31 may have a variety of shapes and sizes, and in one embodiment may have an average length of less than 1.5 millimeters. In another embodiment of the present invention the hooks 31 have an average hook length of less than about 1 millimeter, or less than about 0.5 millimeters, or have an average length of between about 0.2 and about 0.4 millimeters. The hooks 31 may be coupled to and extend generally perpendicularly from a backing surface 32 and may have some curvature, as shown in FIG. 3.

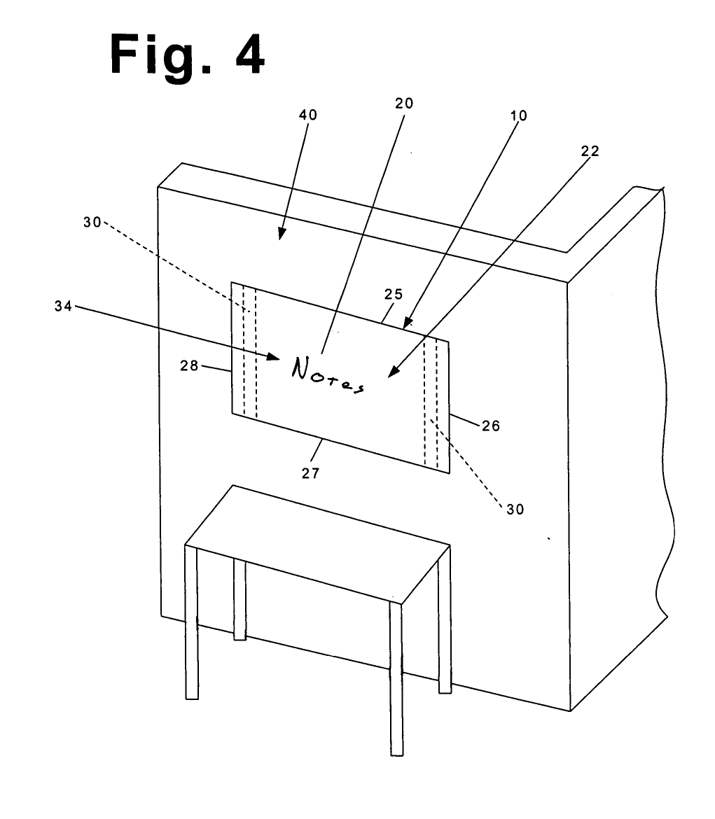

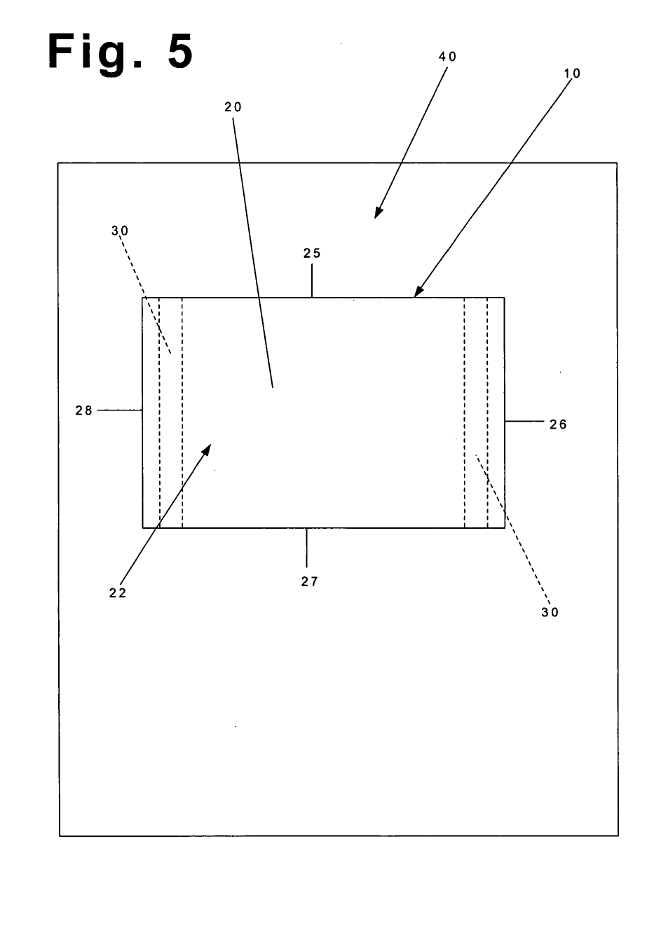

As best shown in FIGS. 4 and 5, the poster board 20 of the present invention may be attached to a mounting surface 40 by mating the strips of hook material 30 directly with a mounting surface 40. Mating of the strips of hook material 30 and mounting surface 40 may be accomplished by pressing the hooks 31 of the strips of hook material 30 into contact with the mounting surface 40.

The mounting surface 40 can be any of a wide variety of surfaces, such as fabric or fabric covered surfaces, or nearly any surface which has loops, strands, fibers, or the like which can interact with the hooks 31 of the strips of hook material 30 so that the poster board 20 can be suspended from the mounting surface 40. The hooks 31 interacts with the fibers on the mounting surface 40 to releasably attach the poster board 10 to the surface 40. The poster board 20 can be separated from the mounting surface 40 by simply pulling the board 20 away from the mounting surface 40, which in turn separates the hooks 31 of the strips of hook material 30 from the mounting surface 40.

The mounting surface 40 may be a vertically oriented fabric surface having a surface area greater than the surface area of the poster board 20. For example, as shown in FIG. 4, the mounting surface 40 may be the wall of a cubicle, partition, or the like. The mounting surface 40 may also be fabric bulletin boards, fabric covered walls, fabric-based wallpaper, or the like. The larger surface area of the mounting surface 40 allows the entire surface area of the strips of hook material 30 to interact directly with the mounting surface 40, thereby providing the greatest adhesion to the mounting surface 40 and provides flexibility with respect to where to locate the poster board 20. However, the poster board 20 may also be used with corresponding patches of hook and loop fastening material (i.e. strips of loops or loop material, not shown) that are mounted to the mounting surface 40.

The relatively short hook lengths of the hook material 30 allow the poster board 20 to be closely attached to the mounting surface 40 due to the relative shortness of the hooks 31. Because of the short length of the hooks 31, bowing of the areas of the poster board 20 which are not located adjacent to the hook material 30 is minimized. For example, in the illustrated embodiment if a user were to write on the center of the poster board 20 (which is spaced away from the portions of hook material 30 located adjacent to the edges 26, 28), the pressure exerted by the user while writing may cause some curvature or bowing of the poster board 20 in its center. However, the short length of the hooks 31 minimizes such bowing or curvature. Thus it is easier to write various text 34 on the center of the poster board 20 and any deformation of the poster board 20 is minimized.

Furthermore, the short length of the hooks 31 provides a smooth transition when writing on or over the portions of the front surface 22 of the poster board 20 located over the strips of hook material 30. For example, in the illustrated embodiment, if a user were to write text 34 on the poster board 20 adjacent to the edges 26, 28, the pressure exerted by the user on the board may again cause curvature of the board 20 along the edges of the portions of hook material 30 to form “ridges.” However, the relatively short length of the hooks 31 reduces the height of the “ridges” that may arise adjacent to the portions of hook material 30 and enable a user to smoothly write upon the entire surface area of the poster board 20, including along the outer edges 26, 28. When the hooks 31 have the lengths specified herein and a standard writing instrument is used (i.e. a pen, pencil or the like) the size of the ridges as compared to the writing instrument may be small enough that a user can easily write over the ridges. For example, when using a ball point pen, the diameter of the ball of the ball point pen may be comparable to the height of the ridge so that the ball and smoothly roll up and over the ridge.

Typical hook-and-loop fastening material (i.e. as used in clothes and the like) may have a hook length of about 2 millimeters. However, use of such hook-and-loop fastening materials on the back of a poster board may cause significant bowing and ridges adjacent to the strips of hook-and-loop fastening material, and do not provide the advantages of the hooks 31 having the reduced lengths as specified herein.

Although the invention is shown and described with respect to certain embodiments it is obvious that equivalents and modifications will occur to those skilled in the art upon reading and understanding the specification. The present invention includes all such equivalents and modifications and is limited only by the scope of the claims.

1. A poster board system comprising:
a piece of sheet-like material having a front surface and a rear surface; and
at least one portion of hook material coupled to said rear surface of said piece of sheet-like material, wherein said hook material is a portion of hook-and-loop fastening material having an average hook length of less than about 1.5 millimeters.

2. The poster board system of claim 1 wherein said average hook length is less than about 0.5 millimeters.

3. The poster board system of claim 1 wherein said piece of sheet-like material includes a cellulose based material.

4. The poster board system of claim 1 wherein said front surface of said piece of sheet-like material is a writing surface capable of absorbing a water-based ink.

5. The poster board system of claim 1 wherein said piece of sheet-like material is generally rectangular in front view.

6. The poster board system of claim 1 wherein said piece of sheet-like material has a surface area of at least about 80 square inches.

7. The poster board system of claim 1 wherein said hook material is laminated to said rear surface of said piece of sheet-like material.

8. The poster board system of claim 1 further comprising a supplemental portion of hook material coupled to said rear surface and spaced apart from said portion of hook material.

9. The poster board system of claim 8 wherein each of said portions of hook material extend generally adjacent to an outer edge of said piece of sheet-like material.

10. The poster board system of claim 1 wherein said piece of sheet-like material includes a plurality of outer edges and wherein said at least one portion of hook material extends generally between two of said outer edges.

11. The poster board system of claim 1 further comprising a mounting surface for interacting with said hook material such that said hook material is releasably attachable to said mounting surface to thereby mount said piece of sheet-like material to said mounting surface.

12. The poster board system of claim 11 wherein said mounting surface has a surface area greater than a surface area of said piece of sheet-like material.

13. The poster board system of claim 11 wherein said mounting surface is a fabric surface.

14. The poster board system of claim 11 wherein said mounting surface is oriented generally vertically.

15. The poster board system of claim 1 wherein said piece of sheet-like material has a thickness of less than about 0.05 inches.

16. A poster board system comprising:
a piece of sheet-like material having a front surface and a rear surface; and
at least one portion of hook material coupled to said rear surface of said piece of sheet-like material, wherein said hook material is a portion of hook-and-loop fastening material, and wherein said piece of sheet-like material includes a plurality of outer edges and wherein said at least one portion of hook material extends between two of said outer edges.

17. The poster board system of claim 16 wherein said hook material is a portion of hook-and-loop fastening material having an average hook length of less than about 1.5 millimeters.

18. The poster board system of claim 17 wherein said average hook length is less than about 0.5 millimeters.

19. The poster board system of claim 16 wherein said piece of sheet-like material includes a cellulose based material.

20. The poster board system of claim 16 wherein said front surface of said piece of sheet-like material is a writing surface capable of absorbing a water-based ink.

21. The poster board system of claim 16 wherein said piece of sheet-like material is generally rectangular in front view.

22. The poster board system of claim 16 wherein said piece of sheet-like material has a surface area of at least about 80 square inches.

23. The poster board system of claim 16 wherein said hook material is laminated to said rear surface of said piece of sheet-like material.

24. The poster board system of claim 16 further comprising a supplemental portion of hook material coupled to said rear surface and spaced apart from said portion of hook material.

25. The poster board system of claim 24 wherein each of said portions of hook material extend generally adjacent to an outer edge of said piece of sheet-like material.

26. The poster board system of claim 16 further comprising a mounting surface for interacting with said hook material such that said hook material is releasably attachable to said mounting surface to thereby mount said piece of sheet-like material to said mounting surface.

27. The poster board system of claim 26 wherein said mounting surface has a surface area greater than a surface area of said piece of sheet-like material.

28. The poster board system of claim 26 wherein said mounting surface is a fabric surface.

29. The poster board system of claim 26 wherein said mounting surface is oriented generally vertically.

30. The poster board system of claim 16 wherein said piece of sheet-like material has a thickness of less than about 0.05 millimeters.

31. A method for hanging a poster board comprising the steps of:
providing a poster board having a front surface, a rear surface, and at least one portion of hook material coupled to said rear surface, wherein said hook material is a portion of hook-and-loop fastening material, said poster board being generally rectangular and having a surface area of at least about 80 square inches; and
placing said piece of sheet-like material against a mounting surface such that said hook material is releasably attachable to said mounting surface to thereby hang said poster board.

32. The method of claim 31 wherein said hook material has an average hook length of less than about 1.5 millimeters

33. The method of claim 31 wherein said average hook length is less than about 0.5 millimeters.

34. The method of claim 31 wherein said piece of sheet-like material includes a cellulose based material.

35. The method of claim 31 wherein said front surface of said piece of sheet-like material is a writing surface capable of absorbing a water-based ink.

36. The method of claim 31 wherein said piece of sheet-like material is generally rectangular in shape.

37. The method of claim 31 wherein said piece of sheet-like material has a surface area of at least 100 square inches.

38. The method of claim 31 wherein said at least one portion of hook material is laminated to said rear surface of said piece of sheet-like material.

39. The method of claim 31 wherein each of said at least one portion of hook material extends adjacent to an outer edge of said piece of sheet-like material.

40. The method of claim 31 wherein said at least one portion of hook material extends along a length of said piece of sheet-like material.

41. The method of claim 31 wherein said mounting surface has a surface area greater than a surface area of said piece of sheet-like material.

42. The method of claim 31 wherein said mounting surface is a fabric surface.

43. The method of claim 31 wherein said mounting surface is oriented generally vertically.

44. The method of claim 31 wherein said poster board system further includes a supplemental portion of hook material coupled to said rear surface and spaced apart from said portion of hook material.

45. The method of claim 44 wherein each of said portions of hook material extend generally adjacent to an outer edge of said piece of sheet-like material.
